(19) United States
(12) Patent Application Publication
(10) Pub. No.: US 2026/0056108 A1
(43) Pub. Date: Feb. 26, 2026

(54) A System and Method for Enumerating Microorganisms

(71) Applicant: Nanyang Technological University, Singapore (SG)

(72) Inventors: Xinhui Shen, Singapore (SG); Ting Wei Teo, Singapore (SG); Tian Fook Kong, Singapore (SG); Marcos,- -None-, Singapore (SG)

(21) Appl. No.: 18/876,495

(22) PCT Filed: Jun. 21, 2023
(86) PCT No.: PCT/SG2023/050437

§ 371 Date: Dec. 18, 2024

(30) Foreign Application Priority Data
Jul. 19, 2022 (SG) 10202250512F

(51) Int. Cl. G01N 15/01; G01N 15/06

(52) U.S. Cl. CPC G01N 15/01; G01N 2015/0662

(57) ABSTRACT

This document describes a system and method for enumerating a concentration of microorganism in a liquid sample. The disclosed system has a filtration medium that has an inlet for receiving the liquid sample and an outlet for removing a filtered liquid sample from the filtration medium. A differential pressure sensor having a first port connected to the inlet of the filtration medium and a second port connected to the outlet of the filtration medium is also provided in this system and the differential pressure sensor is configured to measure a pressure difference between the inlet and outlet of the filtration medium over a period. The system also has a computing module that is communicatively connected to the differential pressure sensor whereby the computing module is configured to enumerate the concentration of the microorganism in the liquid sample based on the measured pressure difference over the period and a pre-generated calibration model.

### CROSS-REFERENCE TO RELATED APPLICATION

This application claims the benefit of priority to the Singapore application no. 10202250512F filed 19 Jul. 2022, the contents of which is hereby incorporated by reference in its entirety for all purposes.

### TECHNICAL FIELD

This application relates to a system and method for enumerating a concentration of microorganism in a liquid sample.

### BACKGROUND

According to the World Health Organization, every year, millions of people across the globe become infected with pathogenic bacteria like Escherichia coli and Salmonella enterica by consuming contaminated food or water. As a result, the step of determining the amount of microorganisms such as bacteria present in food and water, which is known as bacteria enumeration, has become essential in many industries and microbiology labs as this practice can determine whether the food or water is harmful for human consumption. Various methods such as viable plate count, direct microscopic count, and turbidimetric method have been developed to determine the density of bacteria in aqueous solution. Despite efforts of those skilled in the art to simplify and streamline the enumeration process, the current techniques still possess several constraints, such as being time-consuming, costly, or the technique may only be applied to the bacteria sample within a certain range of concentration, and many others.

### SUMMARY

In one aspect, the present application discloses a system for enumerating a concentration or an absolute amount of a microorganism in a liquid sample. The disclosed system has a filtration medium that has an inlet for receiving the liquid sample and an outlet for removing a filtered liquid sample from the filtration medium. A differential pressure sensor having a first port connected to the inlet of the filtration medium and a second port connected to the outlet of the filtration medium is also provided in this system and the differential pressure sensor is configured to measure a pressure difference between the inlet and outlet of the filtration medium over a period. The system also has a computing module that is communicatively connected to the differential pressure sensor whereby the computing module is configured to enumerate the concentration of the microorganism in the liquid sample based on the measured pressure difference over the period and a pre-generated calibration model.

In another aspect, the present application discloses a computing module for enumerating the concentration of a microorganism in a liquid sample. In this aspect, the computing module comprises a processing unit and a non-transitory media readable by the processing unit, the media storing instructions that when executed by the processing unit, causes the processing unit to receive a measured pressure difference between an inlet and an outlet of a filtration medium when the liquid sample is infused through the inlet and outlet of the filtration medium over a period. The processing unit then enumerates the concentration of the microorganism in the liquid sample based on the received measured pressure difference and a pre-generated calibration model.

In yet another aspect, the present application discloses a method for enumerating the concentration of a microorganism in a liquid sample. The method includes the step of infusing the liquid sample through an inlet and an outlet of a filtration medium over a period and then measuring, using a differential pressure sensor having sensor ports communicatively coupled to the inlet and outlet of the filtration medium, a pressure difference between the inlet and outlet of the filtration medium. The method subsequently enumerates, using a computing module communicatively connected to the differential pressure sensor, the concentration of the microorganism in the liquid sample based on the measured pressure difference over the period and a pre-generated calibration model.

### BRIEF DESCRIPTION OF THE DRAWINGS

Various embodiments of the present disclosure are described below with reference to the following drawings:

FIG. 1 illustrates a block diagram of a system for enumerating the concentration of microorganisms in a liquid sample in accordance with an embodiment of the present disclosure;

FIG. 2 illustrates a block diagram representative of a processing system for performing embodiments of the present disclosure;

FIG. 3 illustrates a plot of differential pressure across a filtration medium over time when a concentration of 5×10⁷ CFU E. coli was infused into the filtration medium after 350 seconds;

FIG. 4 illustrates a plot of differential pressure across a filtration medium over time when additional concentrations of 5×10⁷ CFU E. coli was infused into the filtration medium at 400 second intervals;

FIG. 5 illustrates a plot of a calibration curve that illustrates the relationship between the differential pressure across a filtration medium and the concentration of bacteria infused into the filtration medium;

FIG. 6 illustrates a plot of another calibration curve that shows the relationship between the enumerated concentration of bacteria infused into a filtration medium and the actual concentration of bacteria;

FIG. 7 illustrates a box and whisker graph that shows the limit of detection of the system in accordance with an embodiment of the present disclosure;

FIG. 8 illustrates a plot that shows the detailed relationship between the differential pressure across a filtration medium and the absolute concentration of E. coli;

FIG. 9 illustrates a plot of a calibration curve that illustrates the relationship between the differential pressure across a filtration medium and the concentration of of Nannochloropsis algae infused into the filtration medium;

FIG. 10 illustrates plots of differential pressure across a filtration medium over time when deionized water was infused into the filtration medium in three sequential runs;

FIG. 11 illustrates plots of normalized hydraulic resistance over time when six different concentrations of bacteria were infused into the filtration medium;

FIG. 12 illustrates a plot of yet another calibration curve that shows the relationship between the concentration of bacteria infused into the filtration medium and the time required for the concentration of bacteria to arrive at a normalized hydraulic resistance, \tilde{R}=1.5, i.e. termination time measurements;

FIG. 13 illustrates equivalent electric circuits of a filtration medium before the filtration medium is infused with concentrations of bacteria and after the filtration medium is infused with concentrations of bacteria;

FIG. 14 illustrates log-log plots of bacterial density as obtained from the proposed enumeration system and agar plate count for 24 bacterial samples at various bacterial densities; and

FIG. 15 illustrates a flowchart that sets out the process or method for enumerating the concentration of microorganisms in a liquid sample in accordance with an embodiment of the present disclosure.

### DETAILED DESCRIPTION

The following detailed description is made with reference to the accompanying drawings, showing details and embodiments of the present disclosure for the purposes of illustration. Features that are described in the context of an embodiment may correspondingly be applicable to the same or similar features in the other embodiments, even if not explicitly described in these other embodiments. Additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance as generally understood in the relevant technical field, e.g., within 10% of the specified value.

As used herein, the term “and/or” includes any and all combinations of one or more of the associated listed items.

As used herein, “comprising” means including, but not limited to, whatever follows the word “comprising”. Thus, use of the term “comprising” indicates that the listed elements are required or mandatory, but that other elements are optional and may or may not be present.

As used herein, “consisting of” means including, and limited to, whatever follows the phrase “consisting of”. Thus, use of the phrase “consisting of” indicates that the listed elements are required or mandatory, and that no other elements may be present.

As used herein, the terms “microorganism” and “organism” mean a member of one of following classes: fungi, algae, bacteria, protozoa, and may also include, for purposes of the present disclosure, viruses, prions, or other pathogens. In various embodiments, bacteria, and in particular, human and animal pathogens, are evaluated. Suitable microorganisms include any of those well established in the medical art and those novel pathogens and variants that emerge from time to time.

Further, one skilled in the art will recognize that certain functional units in this description have been labelled as modules throughout the specification. The person skilled in the art will also recognize that a module may be implemented as circuits, logic chips or any sort of discrete component. Still further, one skilled in the art will also recognize that a module may be implemented in software which may then be executed by a variety of processor architectures. In embodiments of the disclosure, a module may also comprise computer instructions or executable code that may instruct a computer processor to carry out a sequence of events based on instructions received. The choice of the implementation of the modules is left as a design choice to a person skilled in the art and does not limit the scope of the claimed subject matter in any way.

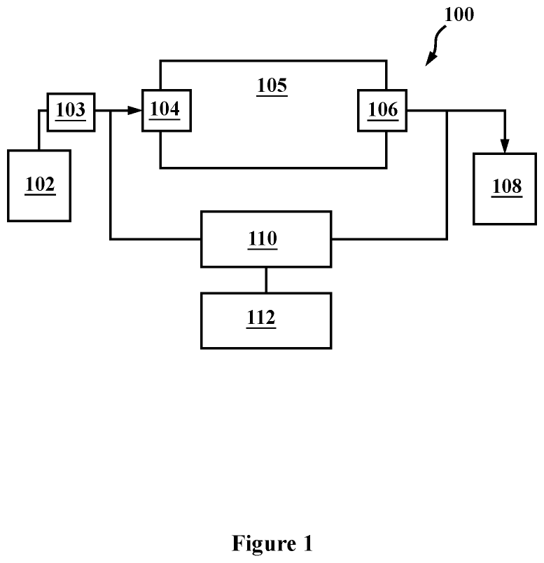

A system for enumerating a concentration or an absolute amount of a microorganism in a liquid sample is illustrated in FIG. 1. As illustrated, system 100 comprises reservoir 102, pump 103, filtration medium 105 that is provided with inlet 104 and outlet 106, differential pressure sensor 110, computing module 112 and reservoir 108. System 100 may also include a calibration module (not shown) that may be provided within computing module 112 or may be provided as a standalone module.

Reservoir 102 is configured to store liquid samples of a microorganism. Pump 103, which is in fluid connection with reservoir 102 and inlet 104, is used to pump the liquid samples from reservoir 102 into filtration medium 105 through inlet 104 at a fixed flow rate for a time-period. In embodiments of the present disclosure, pump 103 may comprise, but is not limited to, a peristaltic pump or a pressure driven flow-control system. In further embodiments of the pressure disclosure, reservoir 102 and pump 103 may be combined into a single pump setup such as a syringe driven pump. The liquid from reservoir 102 is pumped into inlet 104. The liquid then infuses through filtration medium 105, and exits filtration medium 105 through outlet 106, and subsequently into reservoir 108. In embodiments of the present disclosure, filtration medium 105 may comprise a micro-pore filter, a filtration membrane with micrometer pore sizes, a microfluidic device packed with porous media or any other type of filtration media whose pore sizes are sufficiently small to trap and/or filter microorganisms. Filtration medium 105 with suitably sized micro-pores are used in this embodiment as such a medium would be effective for trapping and isolating unwanted particles such as dust, bacteria, virus, and so on. As filtration medium 105 starts to become obstructed with contaminants, the differential pressure across filtration medium 105 will change accordingly. This change in the differential pressure across filtration medium 105 may be measured by differential pressure sensor 110.

Differential pressure sensor 110 is provided with two sensor ports whereby a first sensor port is communicatively coupled to inlet 104 and a second sensor port is communicatively coupled to outlet 105 such that differential pressure sensor 110 may measure the pressure difference across filtration medium 105 over a period of time. In embodiments of the disclosure, differential pressure sensor 110 may comprise, but is not limited to, a pressure transducer such as a piezoelectric pressure transducer, a capacitive pressure transducer, or a piezoresistive pressure transducer. Computing module 112, which is communicatively connected to differential pressure sensor 110, is then configured to enumerate the concentration of the microorganism in the liquid sample based on the measured pressure difference across filtration medium 105 over the period of time and a pre-generated calibration model. In embodiments of the disclosure, a calibration module (not shown) may be used to pre-generate the calibration model and the calibration module may be provided within computing module 112 or may be provided as a separate module.

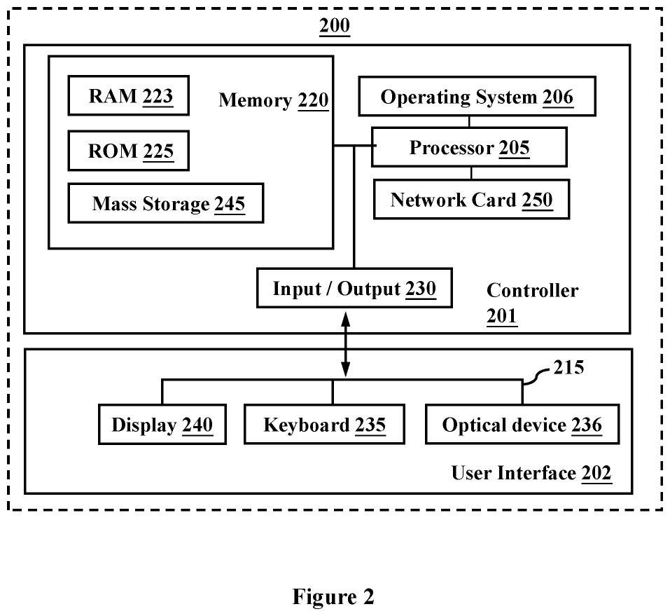

In accordance with embodiments of the present disclosure, a block diagram representative of components of processing system 200 that may be provided within computing module 112, calibration module or any other modules of the system is illustrated in FIG. 2. One skilled in the art will recognize that the exact configuration of each processing system provided within these modules may be different and the exact configuration of processing system 200 may vary and the arrangement illustrated in FIG. 2 is provided by way of example only

In embodiments of the invention, processing system 200 may comprise controller 201 and user interface 202. User interface 202 is arranged to enable manual interactions between a user and the computing module as required and for this purpose includes the input/output components required for the user to enter instructions to provide updates to each of these modules. A person skilled in the art will recognize that components of user interface 202 may vary from embodiment to embodiment but will typically include one or more of display 240, keyboard 235 and optical device 236.

Controller 201 is in data communication with user interface 202 via bus 215 and includes memory 220, processor 205 mounted on a circuit board that processes instructions and data for performing the method of this embodiment, an operating system 206, an input/output (I/O) interface 230 for communicating with user interface 202 and a communications interface, in this embodiment in the form of a network card 250. Network card 250 may, for example, be utilized to send data from these modules via a wired or wireless network to other processing devices or to receive data via the wired or wireless network. Wireless networks that may be utilized by network card 250 include, but are not limited to, Wireless-Fidelity (Wi-Fi), Bluetooth, Near Field Communication (NFC), cellular networks, satellite networks, telecommunication networks, Wide Area Networks (WAN) and etc.

Memory 220 and operating system 206 are in data communication with CPU 205 via bus 210. The memory components include both volatile and non-volatile memory and more than one of each type of memory, including Random Access Memory (RAM) 223, Read Only Memory (ROM) 225 and a mass storage device 245, the last comprising one or more solid-state drives (SSDs). One skilled in the art will recognize that the memory components described above comprise non-transitory computer-readable media and shall be taken to comprise all computer-readable media except for a transitory, propagating signal. Typically, the instructions are stored as program code in the memory components but can also be hardwired. Memory 220 may include a kernel and/or programming modules such as a software application that may be stored in either volatile or non-volatile memory.

Herein the term “processor” is used to refer generically to any device or component that can process such instructions and may include: a microprocessor, microcontroller, programmable logic device or other computational device. That is, processor 205 may be provided by any suitable logic circuitry for receiving inputs, processing them in accordance with instructions stored in memory and generating outputs (for example to the memory components or on display 240). In this embodiment, processor 205 may be a single core or multi-core processor with memory addressable space. In one example, processor 205 may be multi-core, comprising—for example—an 8 core CPU. In another example, it could be a cluster of CPU cores operating in parallel to accelerate computations.

In operation, a concentration of a particular type of microorganism will be prepared as a liquid sample and be stored in reservoir 102. Pump 103 is then configured to pump the liquid sample from reservoir 102 into filtration medium 105, through inlet 104, at a fixed rate. The liquid sample will then infuse through filtration medium 105. The filtered liquid sample then exits filtration medium 105 through outlet 106 and is collected at reservoir 108.

### The First Embodiment

In the first embodiment, a relationship is established between the change in differential pressure across filtration medium 105 and the density of the microorganism that was infused through filtration medium 105 over a fixed period, which may comprise a period between 30 seconds and 20 minutes. This is done by measuring the differential pressure across filtration medium 105 using differential pressure sensor 110 and by storing the measured differential pressure in computing module 112. After the differential pressure across filtration medium 105 has been recorded, a standard plate count method was used to determine the actual density of the microorganism in the liquid sample in reservoir 102. The detailed steps of carrying out the standard plate count method were omitted for brevity in this description as such a method is known to one skilled in the art. Computing module 112 is then configured to record the measured actual density of the microorganism in reservoir 102 and to associate this measurement with the measured differential pressure.

The concentration of the microorganism in reservoir 102 is then subsequently increased and after another fixed period, the differential pressure across filtration medium 105 is measured and stored in computing module 112. The standard plate count method was then again used to determine the increased density of the microorganism in the liquid sample in reservoir 102. In a further embodiment, a known concentration of the microorganism may be added to reservoir 102 thereby negating the need to carry out the standard plate count method to determine the density of the microorganism in reservoir 102.

Regardless of the method used to increase the density of the microorganism in reservoir 102, computing module 112 or a calibration module may then be configured to record the measured actual density of the microorganism in reservoir 102 and to associate this measurement with the measured differential pressure. The concentration of the microorganism in reservoir 102 is gradually increased, and the steps above are repeated until a set of measurements comprising the differential pressure across filtration medium 105 and its associated measured density of the microorganism are obtained. One skilled in the art will recognize that computing module 112 and the calibration module may be used interchangeably throughout the description without departing from the inventive concept of this disclosure.

A calibration model is then generated by computing module 112 or the calibration module based on the obtained recorded concentrations of the microorganism and their associated recorded differential pressure measurements, i.e., the obtained set of measurements. At this stage, computing module 112 may also be configured to determine a curve fitting equation for the calibration model.

Upon generation of the calibration model, computing module 112 may then be used to enumerate the concentration of a microorganism in a liquid sample that is infused through filtration medium 105 based on a measured pressure difference across filtration medium 105 and the calibration model.

### Experiment 1 Based on the First Embodiment

In this experiment, the type of microorganism that was used was the Escherichia coli (or E. coli) bacteria. Initially, an E. coli colony was transferred from a nutrient agar plate to a culture tube that contained 5 ml of culture media. The culture tube was then kept inside the incubator for 24 hours at 37° C. and 220 rpm. It was found that the turbidity of the E. coli suspension increased significantly after the incubation period, which indicated that the bacteria sample was viable, and the density of the bacteria presented in the culture tube has increased.

In order to obtain the density of the sample, the standard plate count method may be adopted. It was observed that the concentration of the bacteria sample that has been incubated for 24 hours was in the order of 10⁹ CFU/ml.

Reservoir 102 was first filled with a predetermined volume of deionized water, e.g., 30 ml of deionized water, whereby the volume of deionized water was set to be such that the infusing flow rate may cycle all the liquid in reservoir 102 through filtration medium 105 within a desired time window. Pump 103, which may comprise, but is not limited to, a peristaltic pump, was then switched on and used to pump the deionized water at a relatively constant volume flow rate within the whole system. Differential pressure sensor 110, which may comprise, but is not limited to, two piezoresistive transducers, were then used to measure the pressure values at inlet 104 and outlet 106 until the pressure is stabilized. Subsequently, an initial amount of the bacteria E. coli was then added into reservoir 102, and this was repeated until a rise in the differential pressure was observed, and this was set as the baseline differential pressure. Next, an additional amount of E. coli suspension was added to the reservoir, with the differential pressure sensor 110 used to continuously measure the pressure values at inlet 104 and outlet 106 of filtration medium 105. In this experiment a standard filter with micropores was used as filtration medium 105. After the bacteria suspension passed through the filter, it was observed that there was an increase in the differential pressure across the filter as the pores of the filter were gradually obstructed by the bacteria. The change in differential pressure, Δp=measured differential pressure—baseline differential pressure, are then used to determine the bacterial concentration from the calibration model.

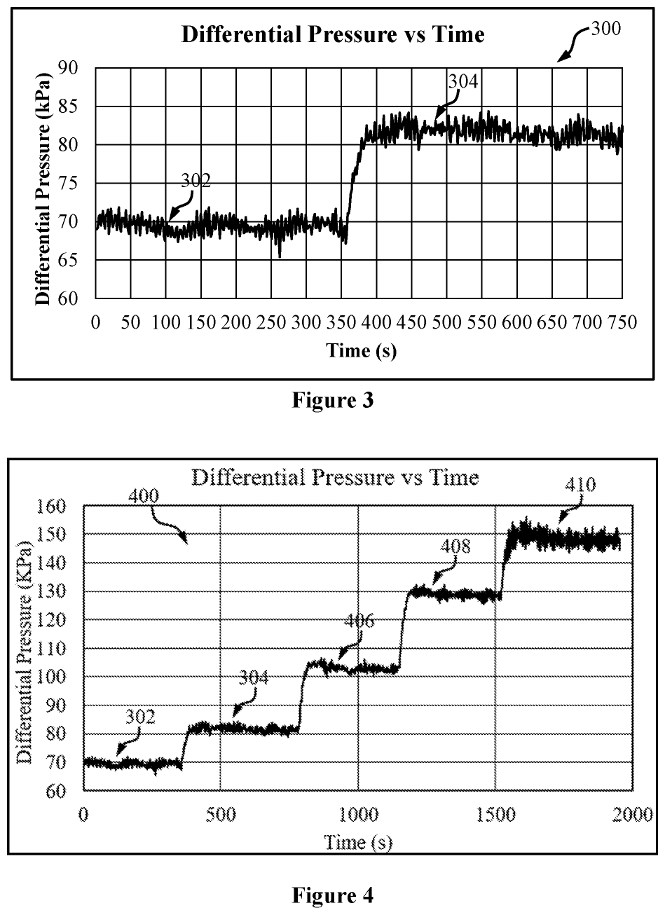

However, it was observed that there was a “blind-zone” in the measured data, as it was observed that the differential pressure across the filter remained the same, i.e., no increase in differential pressure was observed, when less than 5×10⁷ CFU of E. coli was added into reservoir 102 that contained only deionized water. This occurred as the concentration of bacteria was insufficient to block or obstruct many of the micropores of the filter. As a result, the suspension was able to infuse freely through the filter, resulting in an unchanged differential pressure across the filter. It is useful to note at this stage that when only deionized water was pumped through system 100, the differential pressure across the filter was about 70 kPa. After an initial amount of bacteria was added, and once an statistically significant increase in the measured differential pressure was observed above 70 kPa, the increased differential pressure may be taken as the baseline differential pressure. This is illustrated as stage 302 in FIG. 3. It should be noted that the differential pressure across the filter may vary and is dependent on the pore size and diameter of the filter and the infusion flow rate across the filter.

Plot 300 in FIG. 3 illustrates the change in the differential pressure across the filter when 5×10⁷ CFU E. coli suspension was introduced into reservoir 102 after 350 seconds had lapsed. In particular, when 5×10⁷ CFU E. coli suspension was added into reservoir 102, the differential pressure increased from around 70 kPa to around 80 kPa, i.e., from stage 302 to stage 304 in FIG. 3. Therefore, in this experiment, the differential pressure measurement of 80 kPa was used as the baseline differential pressure measurement.

After a further 450 seconds had lapsed (i.e., at the 800 second data point), an additional 5×10⁷ CFU E. coli suspension was introduced into reservoir 102. When this happened, the differential pressure increased from around 80 kPa to around 100 kPa. This is illustrated as stage 406 in plot 400 of FIG. 4.

After a further 400 seconds had lapsed (i.e., at the 1200 second data point), an additional 5×10⁷ CFU E. coli suspension was then introduced into reservoir 102. When this happened, the differential pressure increased from around 100 kPa to around 130 kPa. This is illustrated as stage 408 in plot 400 of FIG. 4.

After a further 400 seconds had lapsed (i.e., at the 1600 second data point), an additional 5×10⁷ CFU E. coli suspension was then introduced into reservoir 102. When this happened, the differential pressure increased from around 130 kPa to around 150 kPa. This is illustrated as stage 410 in plot 400 of FIG. 4.

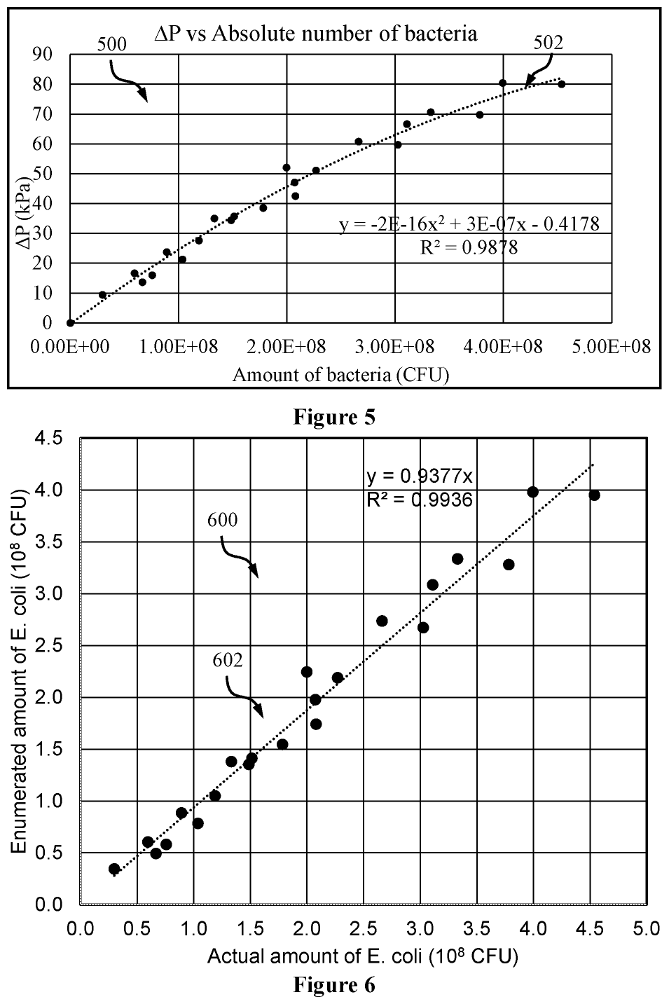

The average value of the differential pressure at each of the stages were calculated, and these values were subtracted by the baseline pressure value, i.e., 80 kPa. To recap, the baseline pressure value comprised the threshold pressure that was obtained after the first 5 ml 10⁷ CFU/ml bacteria solution was added inside the reservoir. The data points which show the relationship between the change in differential pressure, Δp=measured differential pressure—baseline differential pressure, and the absolute number of E. coli trapped by the filter was then obtained and plotted as plot 500 in FIG. 5. Calibration curve 502 was then plotted by curve fitting the plotted data points and the resulting curve fitting equation y=−2e⁻¹⁶x²+3e⁻⁷x−0.4178 had an excellent linear regression value of R²=0.9878.

Once a calibration model comprising calibration curve 502 and the resulting curve fitting equation was obtained, the experimental setup above may then be used to enumerate the unknown concentration of the E. coli suspension that was introduced into reservoir 102. This is done based on the measured pressure difference across the filter and the generated calibration model.

In order to test the accuracy of calibration curve 502 and its associated curve fitting equation, various unknown concentrations of the E. coli suspension were introduced into reservoir 102. The resulting differential pressure across the filter for each of the concentration levels were recorded and the pre-generated calibration model was then used to calculate the concentration of the E. coli suspension or absolute number of the E. coli in the suspension. The results are then plotted as data points in plot 600 of FIG. 6. Line plot 602 was then plotted by curve fitting the plotted data points and it was found that line plot 602 had a linear regression value of R²=0.9936.

Simultaneously, as the various unknown concentrations of the E. coli were % introduced into reservoir 102, the standard plate count method was used to obtain the actual concentration of E. coli in the suspension in reservoir 102. The comparison between the actual concentrations of E. coli and the calculated concentration of the E. coli are set out in Table 1 below.

TABLE 1

| Actual No | | Enumerated No. | Accuracy |
|---|---|---|---|
| of E. coli | ΔP | of E. coli | (%) |
| 1.04E+08 | 21.27 | 7.85E+07 | 75.7 |
| 2.07E+08 | 47.15 | 1.98E+08 | 95.4 |
| 3.11E+08 | 66.67 | 3.09E+08 | 99.3 |
| 7.56E+07 | 16.02 | 5.81E+07 | 76.8 |
| 1.51E+08 | 35.74 | 1.41E+08 | 93.4 |
| 2.27E+08 | 51.11 | 2.19E+08 | 96.5 |
| 3.03E+08 | 59.75 | 2.67E+08 | 88.4 |
| 3.78E+08 | 69.78 | 3.28E+08 | 86.7 |
| 4.54E+08 | 80.05 | 3.95E+08 | 87.1 |
| 6.66E+07 | 13.64 | 4.93E+07 | 74.1 |
| 1.33E+08 | 35.04 | 1.38E+08 | 96.3 |
| 2.00E+08 | 52.14 | 2.24E+08 | 87.6 |
| 2.66E+08 | 60.83 | 2.74E+08 | 97.2 |
| 3.33E+08 | 70.67 | 3.34E+08 | 99.8 |
| 3.99E+08 | 80.51 | 3.98E+08 | 99.7 |
| 2.97E+07 | 9.46 | 3.45E+07 | 83.9 |
| 5.94E+07 | 16.64 | 6.04E+07 | 98.3 |
| 8.91E+07 | 23.76 | 8.86E+07 | 99.4 |
| 1.19E+08 | 27.64 | 1.05E+08 | 88.3 |
| 1.49E+08 | 34.46 | 1.35E+08 | 91.1 |
| 1.78E+08 | 38.54 | 1.55E+08 | 86.8 |
| 2.08E+08 | 42.54 | 1.74E+08 | 83.8 |

The accuracy parameter in Table 1 is defined as

$$Accuracy = [ \text{} 1 - ( \frac{abs ( Enumerated bacteria number - actual bacteria number )}{actual bacteria number} ) ] \times 100 \%$$

From Table 1 above, it is shown the system is able to successfully obtain the concentration of various unknown concentrations of E. coli suspensions with an accuracy of 90.3±±8.0%.

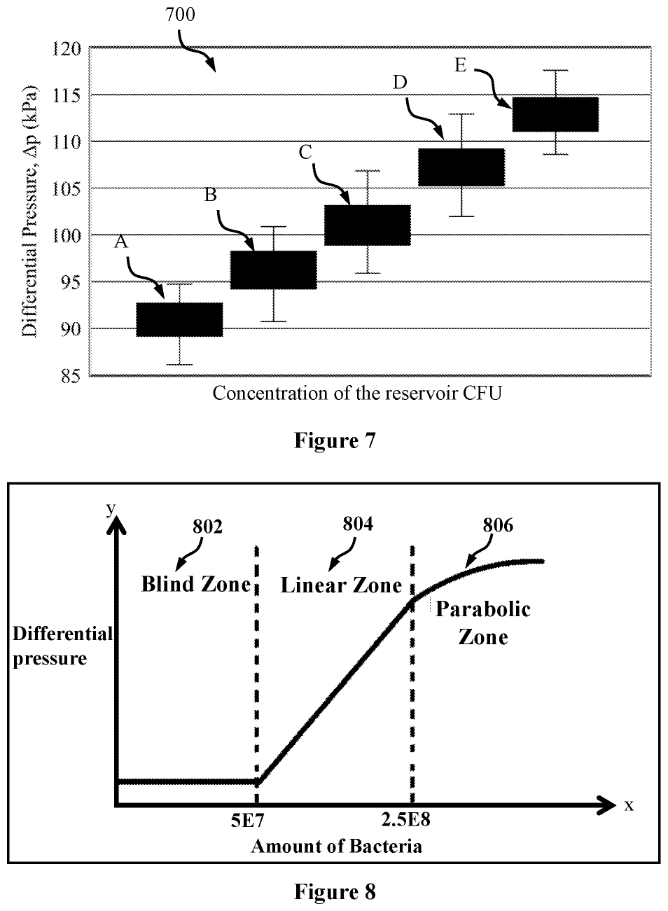

To test the limit of detection of the setup in Experiment 1, after the filter was saturated with deionized water and a certain amount of E. coli were trapped by the filter (absolute number of E. coli: 5×10⁷ CFU), an initial E. coli suspension that was diluted to a density of around 10⁶ CFU was infused into the system. After a predetermined period, the differential pressure across the filter was recorded. The amount of E. coli was then gradually increased, recorded (using the standard plate count method) and introduced into the system. For each recorded amount, the corresponding differential pressures across the filter were then recorded. The obtained results were then used to plot box and whisker graph 700 in FIG. 7 (which shows the limit of detection) when the concentration of the reservoir is increased by 10⁶ CFU each step from sample A-E.

It was observed that the differential pressure response across the filter comprised three zones when the concentration of bacteria infused into the filter gradually increased. In the initial “blind zone 802”, no pressure increase was detected until a certain threshold of bacteria were trapped (absolute number of E. coli: 5×10⁷ CFU) in the pores of the filter. As such, in certain embodiments, the set of measurement associated with the blind-zone may be removed from the measurements used to determine the curve fitting equation for the calibration model. In the subsequent “linear zone 804”, the differential pressure exhibited a linear correlation with the increase in the concentration of bacteria that was infused through the filter. Finally, the differential pressure response transitioned to a “parabolic zone 806” which exhibited a parabolic correlation (above 2.5×10⁸ CFU) to the increase in the concentration of bacteria that was infused through the filter.

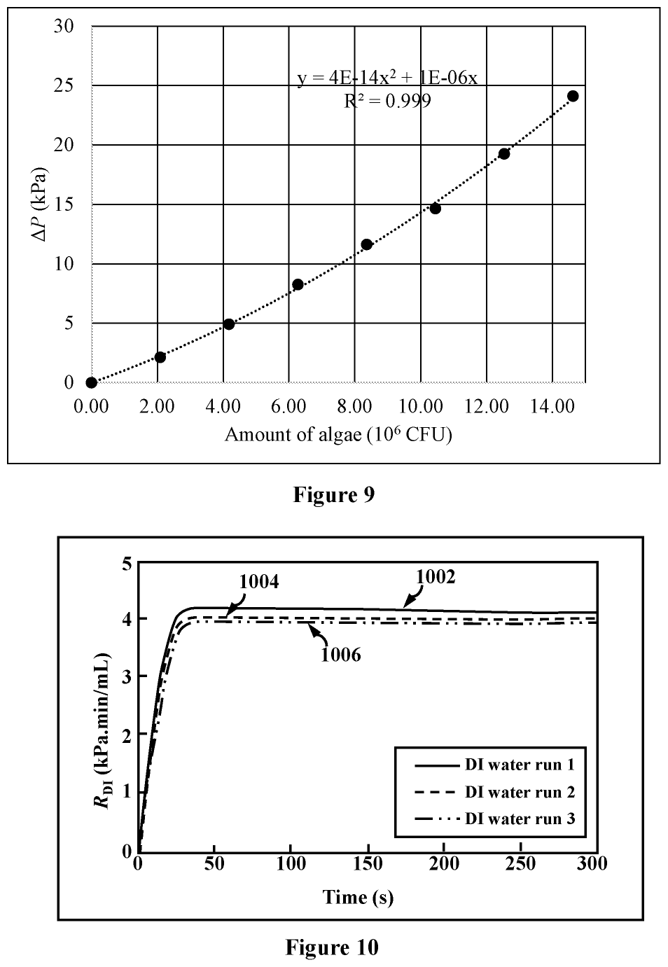

In addition, the enumeration technique described above was used for the enumeration of Nannochloropsis algae (diameters ranging from 2-3 μm). The change in differential pressure, ΔP and amount of the algae was plotted in FIG. 9 and shows an excellent goodness of fit R²=0.999, which demonstrates that the enumeration technique works well for algae as well.

Table 2 below compares the parameters/characteristics of system 100 and various other types of microorganism enumeration systems that are used by those skilled in the art. From the results, microorganism enumeration system 100 has a larger detection range and costs much less as compared to existing systems. Further, system 100 is able to accurately enumerate the amount of a microorganism in a liquid sample in a shorter amount of time as compared to the other existing system.

TABLE 2

| | | | McFarland/ | | | |
|---|---|---|---|---|---|---|
| Parameters/ | System | Agar plate | OD600 | Flow | BacTrac/ | |
| Characteristics | 100 | count | method | cytometry | RABIT | PCR |
| Enumeration | Actual | Actual | Order | Actual | Actual | Actual |
| | Concentration | Concentration | estimation | Concentration | Concentration | Concentration |
| Detection range | 10⁶ to 10⁹ | 10³ to 10⁸ | 10⁸ | 10¹ to 10⁸ | 10⁶ to 10⁸ | >1 |
| (CFU/ml) | | | | | | |
| Time | <15 mins | 24-48 | 15-60 | 1 hour | Few hours- | Few hours |
| | | hours | mins | | 24 hours | |
| Machine cost | <SGD 200 | — | >SGD 300 | >SGD | >SGD | >SGD 1000 |
| | | | | 100,000 | 13,000 | |
| Measurement | ~SGD 2 | <SGD 10 | <SGD 5 | >SGD 600 | >SGD 10 | >SGD 100 |
| cost | | | | | | |

### The Second Embodiment

In the second embodiment, a relationship is established between the change in differential pressure across filtration medium 105 and the density of the microorganism that was infused through filtration medium 105 over a fixed period which may comprise any period between 30 seconds and 20 minutes.

Similar to the initial steps of the first embodiment, the inherent differential pressure across filtration medium 105 is first obtained when deionized water is pumped through filtration medium 105, i.e., before a liquid sample containing the microorganism is infused through the medium.

As pore geometries and distributions of the filtration membranes may vary among one another, the differential pressure, Δp, across different filtration membranes may vary. To quantify this variation, the hydraulic resistance, R, of filtration medium 105 is first obtained. Hydraulic resistance, R is defined as

$$R = \frac{Δ p}{Q} ,$$

where Q is the flow rate. The steady state hydraulic resistance of filtration medium 105, R_{DI,steady}, is then obtained when deionized water is pumped through medium 105 for a period of time required for the hydraulic resistance of filtration medium 105 to reach a steady state.

In order to compensate for the intrinsic differences in hydraulic resistance among the various filtration membranes, a normalized time-dependent hydraulic resistance is utilized in the subsequent measurements where time-dependent hydraulic resistance is defined as

$$\tilde{R} = \frac{{R}_{Bact}}{{R}_{DI , Steady}} ,$$

where R_{Bact} is the hydraulic resistance of filtration medium 105 when this medium is infused with a liquid sample containing a microorganism at a flow rate Q.

The change in the time-dependent hydraulic resistance, \tilde{R}, for an unknown concentration of the microorganism is then recorded as a function of time. From this data, computing module 112 or the calibration module then determines the termination time, i.e., the time required for the time-dependent hydraulic resistance, \tilde{R}, to reach a predetermined threshold value \tilde{R}ₜₕᵣₑₛ=1.5, for that particular concentration of the microorganism.

One skilled in the art will recognize that threshold value \tilde{R}ₜₕᵣₑₛ may comprise other values between 1.3 and 1.7 and that this range was utilized in this embodiment as it was found that this range of threshold values balances the sample-to-result time and the measurement error by allowing sufficient concentration of microorganisms to be trapped on the filtration medium. The standard agar plate count method is then used to determine the exact concentration of the microorganism that was infused through filtration medium 105 and this information is recorded by computing module 112 or the calibration module.

The concentration of the microorganism in the liquid sample is then increased, and the steps above are repeated until a set of measurements that show the relationship between the concentration of the microorganism and its associated termination time are obtained.

A calibration model is then generated by computing module 112 or the calibration module based on the set of measurements (which comprise the measured concentrations of the microorganism and the recorded termination time measurements associated with the measured concentrations of the microorganism). At this stage, computing module 112 or the calibration module may then be configured to determine a curve fitting equation for the calibration model. In further embodiments, the curve fitting equation may be defined by an equivalent electric circuit based numerical model.

Upon generation of the calibration model, computing module 112 may then be used to enumerate the concentration of a microorganism in a liquid sample that is infused through filtration medium 105 based on a measured pressure difference across filtration medium 105 and the calibration model.

### Experiment 2 Based on the Second Embodiment

In this experiment, the setup comprises a filtration membrane that is 15 mm in diameter with 0.2 μm pore sizes. The filtration membrane's inlet is connected to the outlet of a 50 ml syringe that is driven by a syringe pump at a constant flow rate Q and the inlet of the syringe is in fluid connection with a solution reservoir. The pressure difference, Δp, between the inlet and outlet of the filtration membrane, is measured using a digital differential manometer, and the outlet of the filtration medium is in fluid connection with a filtrate reservoir.

The type of microorganism that was used in this experiment was the Escherichia coli (or E. coli) bacteria. The E. coli samples were obtained by transferring a single colony from a streaked nutrient agar to a culture tube that was filled with 6 ml of Nutrient Broth. The culture tube was then incubated at 37° C. and 250 rpm for 24 hours. Any large debris were then filtered out from the culture by passing the stock solution through three 5-μm filtration membranes that were connected in series. After that, the density of the filtered E. coli was determined via agar plate count by averaging the CFU counts from 10 agar plates. Results showed that the E. coli density varied among different stocks but is in the order of 109 CFU/ml. To eliminate the growth of bacterial cells over the course of the experiment, the bacteria in the filtered stock solution are thermally inactivated immediately after plating. This is done by placing the culture tube in a 98° C. water bath for 25 minutes. Microscopic observation then showed that the E. coli shape remained unchanged after it has been inactivated by the thermal treatment.

Prior to introducing the E. coli concentration into the solution reservoir, the solution reservoir was initially filled with deionized water (DI) and the syringe-pump arrangement was then used to infuse 16.5 ml of deionized water into the filter at the infusing rate Q=3 ml/min. This process was repeated three times, and this was done to calibrate the inherent pressure difference across the filter membrane without bacterial deposition.

The transient response of the hydraulic resistance, R, for three sequential deionized (DI) water runs are illustrated in FIG. 10. From plot 1002 (DI water run 1) in FIG. 10, it is observed that the hydraulic resistance, R, overshoots to 4.2 kPa·min/ml at the time t≈50 s. During this time interval, it was observed that the color of the membrane filter turns from white to clear as it is gradually wetted by the DI water flowing through it. This overshoot was not observed in the subsequent two runs, and it took a shorter amount of time for the hydraulic resistance values of these two runs to arrive at their steady-state values.

From plots 1004 and 806 in FIG. 10, it is observed that the time required for the hydraulic resistance of these two runs to reach a 95% steady-state value is about 12 seconds. It was also observed that the difference in the steady-state hydraulic resistance for the DI water runs 2 and 3 is less than 2.0%. This implies that after the filtration membrane has been wetted after the second DI water run, the steady-state differential pressure reading can be used to determine the hydraulic resistance of a filtration membrane.

Hence, based on the plots in FIG. 10, it was determined that the steady-state hydraulic resistance of the filter, R_{DI,steady}, may be obtained from the second DI water run when the deionized water is pumped through the filter for a period between t=150 and 300 seconds. This value then serves as the reference value to be used in the subsequent bacterial runs.

After establishing the R_{DI,steady} value has been determined, the E. coli concentration is then added to the suspension in the solution reservoir and through the use of the syringe-pump arrangement, the E. coli solution is then infused into the filter at a fixed rate. The transient response of the differential pressure across the filter as the solution is being infused into the filter is recorded using the manometer. As the mean pore size (i.e., about 0.2 μm) of the membrane is much smaller than the main body size of the E. coli, the bacteria will be trapped by the pores of the filter.

In order to compensate for the intrinsic differences in hydraulic resistance among the filtration membranes, the time-dependent hydraulic resistance for bacterial run, R_{Bact}, was normalized with the steady-state hydraulic resistance obtained from the DI water run, R_{DI,steady}, of that particular filter, where the normalized steady-state hydraulic resistance, \tilde{R}, is defined as

$$\tilde{R} = \frac{{R}_{Bact}}{{R}_{DI , Steady}} .$$

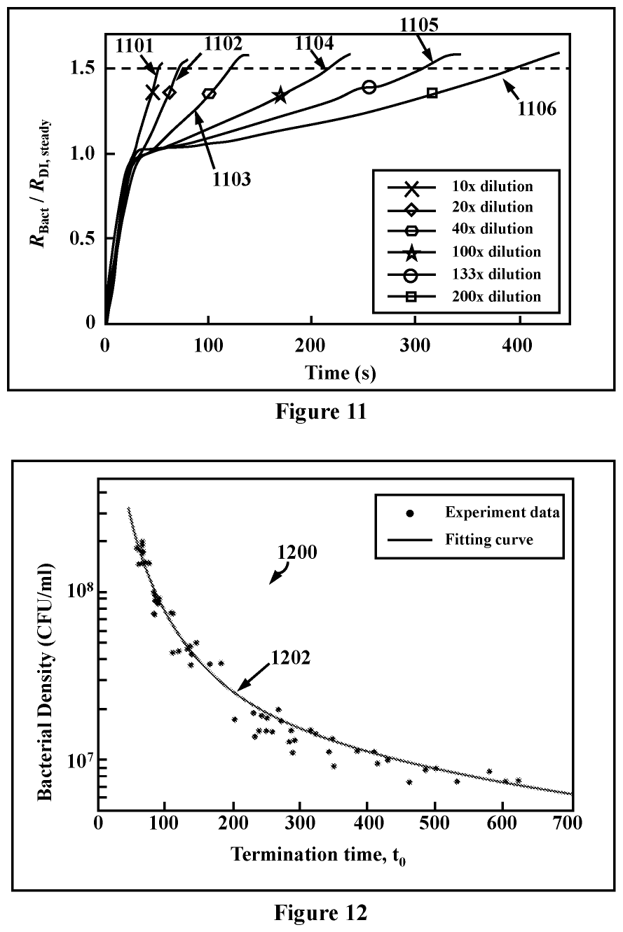

The change in the normalized hydraulic resistance as a function of time was then obtained when six bacterial solutions (10× dilution, 20× dilution, 40× dilution, 100× dilution, 133× dilution, 200× dilution) diluted from a common stock culture with a bacterial density of 2.12×10⁹ CFU/ml (as determined from agar plate count) were infused through the filter. The densities of the bacterial samples typically range from 8.1×10⁶ CFU/ml to 2.2×10⁸ CFU/ml. The changes in the normalized hydraulic resistance for these six bacterial solutions are subsequently plotted in FIG. 11 as plots 1101-1106 and their associated termination times are recorded by the computing module.

The termination time, which is defined as the time required for \tilde{R} to reach its threshold \tilde{R}ₜₕᵣₑₛ=1.5 and denoted by to, is used to determine the number of bacteria trapped on the membrane, i.e., the bacterial density. As mentioned above, the criterion \tilde{R}ₜₕᵣₑₛ=1.5 is an optimized parameter which balances the sample-to-result time and the measurement error by allowing a sufficient concentration of bacteria to be trapped on the membrane of the filter.

Bacterial samples at a higher density are not used in this experiment as it is expected that the pressure differential curve will increase at a rate that is too fast. As a result, it may not be determined whether the pressure increase was due to the transient response of the filter (the fast increase region of R in FIG. 10<50 seconds) or due to the bacterial disposition on the membrane. Further, it was also determined that when the bacterial density was less than 10⁶ CFU/ml, it took about 120 minutes to arrive at the termination time for this bacterial density.

When the bacterial density in the solution was between 10⁶ and 10⁸ CFU/ml, it was observed that the hydraulic resistance in bacterial runs rises non-linearly and becomes higher than that of the DI water run at t>30 seconds.

The steps above were repeated nine more times in order to obtain 60 datapoints (i.e., in total there were ten separate sets of experiments, each with E. coli bacteria prepared at six different dilutions and infused through the filter) and this measurement set was then used to determine the relationship between the bacterial density and termination time.

FIG. 12 illustrates the bacterial density of the inlet solution, as determined by agar plate count, as a function of termination time to. From the data points in plot 1200, it can be observed that there is an inverse relationship between the bacterial density in the infused sample and the associated time required to reach the termination condition (i.e., the termination time). When the bacterial density is in the order 10⁸ CFU/ml, the experiment showed that the system was able to determine the bacterial density in less than 1 minute after the bacteria solution was introduced into the solution reservoir. Conversely, when the bacterial density was reduced to 10⁶ CFU/ml, the system requires a slightly longer time to arrive at the termination condition, i.e., about 12 minutes. This demonstrates that the enumeration system used in this experiment has a large working range (about three orders of magnitude) and rapid detection capabilities.

Calibration curve 1202 was then plotted by curve fitting the plotted data points. Once a calibration model comprising calibration curve 1202 and a resulting curve fitting equation was obtained, the experimental setup above may then be used to enumerate the unknown concentration of the E. coli suspension that was introduced into the solution reservoir. This is done based on the measured pressure difference across the filter and the generated calibration model.

In a further embodiment, an equivalent electric-circuit model was developed to formulate the general form of a calibration curve for the prediction of the bacterial density of a bacterial sample with the sample's termination time. Analogous to how an electric resistor regulates its voltage and current, the pores on the filtration membrane serves as hydraulic resistors, where the size and blockage condition of the filtration membrane determine the pressure difference across the two ends of the filtration membrane over a constant flow rate.

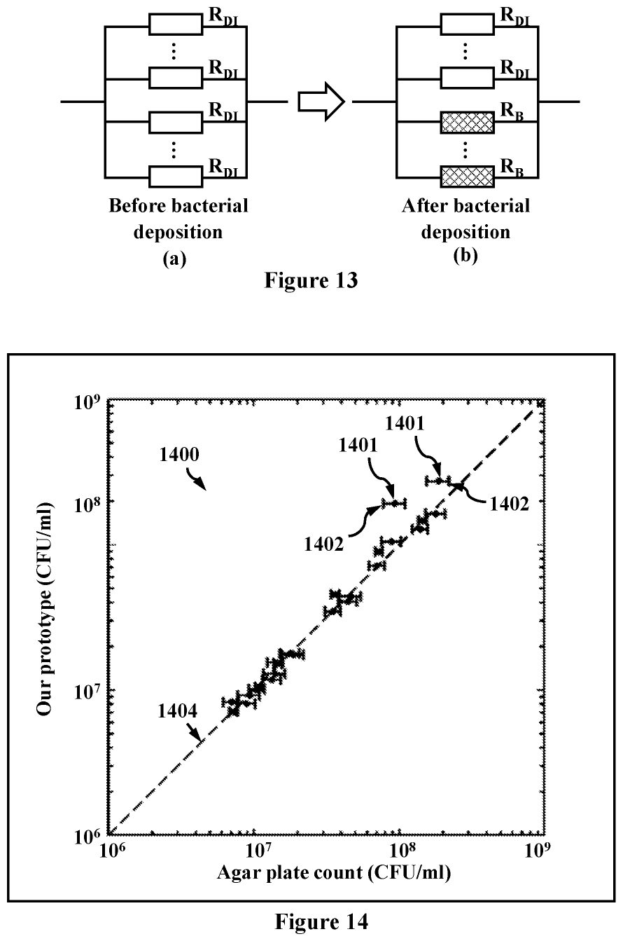

The equivalent electric circuit of the filter is illustrated in FIG. 13(a). It is assumed that the filter comprises a total of N uniformed sized pores that distributed over the surface of the membrane, and the resistance of each pore is denoted by r_{DI}(t). A parallel circuit arrangement of the resistances was adopted, and this results in the steady-state resistance of the membrane without bacterial deposition being defined as:

$${R}_{DI} = \frac{{r}_{DI}}{N}$$

As the infused bacteria are trapped on the membrane, the pores become blocked, and this causes the resistance of these pores to increase. The equivalent electric circuit due to trapped bacteria in the pores is illustrated in FIG. 13(b). As the size of bacteria is much larger than the pore size of the filter, it is assumed that on average, one bacterial cell will block m number of pores, and as a result, the resistance of each blocked pore increases to r_{Bact}. Hence, the overall resistance of the membrane, R_{Bact}, can be related to the bacterial density (in the unit of CFU/ml), c, by the following formula:

$$\frac{1}{{R}_{Bact}} = \frac{N - mcQt}{{r}_{DI}} + \frac{mcQt}{{r}_{Bact}} \qquad ( 1 )$$

where the time dependent responses of r_{DI} and r_{Bact} may be defined as:

$${r}_{DI} = {r}_{0} [ 1 - exp ( - t / τ ) ] ) \qquad ( 2 )$$

$${r}_{Bact} = {r}_{b} [ 1 - exp ( - t / τ ) ] ) \qquad ( 3 )$$

It should be noted that r_{b}>r₀, where r₀(r_{b}) are the averaged steady-state resistance of a pore without (with) bacterial deposition, t is the time in the unit of second, and the time constant τ takes into consideration the transient response of the pressure reading (as shown in FIG. 10). Despite of the zero hydraulic resistance at t=0, it was observed that the model showed a good approximation of the filter's response in the time interval in which the increase in hydraulic resistance of the membrane filter is dominated by the bacterial deposition.

When equations (1)-(3) are rearranged, the relationship between the bacterial density and time may be defined as:

$$c = \frac{{C}_{0} [ ( \tilde{R} - 1 ) + exp ( - t / τ ) ]}{t}$$

where the constant

$${C}_{0} = N / [ mQ \tilde{R} ( 1 - \frac{{r}_{0}}{{r}_{b}} ) ] .$$

At the prescribed threshold \tilde{R}=\tilde{R}ₜₕᵣₑₛ=1.5, it was determined that when the coefficients C₀=9.5×10⁹ CFU·s/ml and τ=61.5 seconds, this results in the optimal theoretical curve with a linear regression value of R²=0.955 (plot 1202 in FIG. 12). It should be noted that the two constants, C₀ and τ, can be obtained with a few rounds of agar plate count and termination time determination of the filter.

Upon successful generation of the calibration model which describes the relationship between the bacterial density and the associated termination time, an experiment was further conducted to validate the proposed empirical model and to quantify the accuracy of the system. The bacterial density in the blind test sets typically ranged between 7.3×10⁶ CFU/ml to 1.9×10⁸ CFU/ml.

In the blind test, the averaged measurement accuracy of the proposed system was determined using 24 E. coli bacterial samples of randomized densities but all within the working range of the system. FIG. 14 illustrates the log-log plots of bacterial densities as obtained by the proposed system based on the measured differential pressure across the filter and the pre-generated calibration model against the agar plate count for the 24 samples. In plot 1400, each of the solid dots 1401 represents bacteria densities evaluated by the agar plate count method and our calibration model, while each of the horizontal error bars 1402 represent the standard deviation for the agar plate count. The dashed line 1404 is a reference line representing the perfect match of the results obtained by the two methods.

TABLE 3

| Bacteria density | | Bacteria density | |
|---|---|---|---|
| from agar plate count | Termination | from the prototype | |
| (CFU/ml) | Time (s) | (CFU/ml) | Error |
| (1.79 ± 0.27) × 10⁸ | 53.5 | 1.63 × 108 | 8.67 |
| (8.93 ± 1.33) × 10⁷ | 72.8 | 1.05 × 108 | 17.67 |
| (4.47 ± 0.67) × 10⁷ | 140.7 | 4.06 × 107 | 9.10 |
| (1.79 ± 0.27) × 10⁷ | 272.2 | 1.79 × 107 | 0.04 |
| (1.34 ± 0.20) × 10⁶ | 404.9 | 1.18 × 107 | 12.25 |
| (8.93 ± 1.33) × 10⁶ | 590.1 | 8.04 × 106 | 9.93 |
| (1.87 ± 0.32) × 10⁸ | 36.5 | 2.73 × 108 | 46.02 |
| (9.36 ± 1.60) × 10⁷ | 47.4 | 1.93 × 108 | 105.81 |
| (4.68 ± 0.80) × 10⁷ | 132.5 | 4.41 × 107 | 5.67 |
| (1.87 ± 0.32) × 10⁷ | 277.7 | 1.75 × 107 | 6.71 |
| (1.40 ± 0.24) × 10⁷ | 370.5 | 1.29 × 107 | 8.33 |
| (9.36 ± 1.60) × 10⁶ | 517.1 | 9.18 × 106 | 1.90 |
| (1.41 ± 0.17) × 10⁸ | 63.6 | 1.28 × 108 | 9.35 |
| (7.04 ± 0.86) × 10⁷ | 94.7 | 7.16 × 107 | 1.74 |
| (3.52 ± 0.43) × 10⁷ | 157.7 | 3.47 × 107 | 1.35 |
| (1.41 ± 0.72) × 10⁷ | 310 | 1.55 × 107 | 10.12 |
| (1.06 ± 0.13) × 10⁷ | 469.7 | 1.01 × 107 | 4.21 |
| (7.04 ± 0.86) × 10⁶ | 576.7 | 8.23 × 106 | 16.92 |
| (1.45 ± 0.09) × 10⁸ | 57.7 | 1.47 × 108 | 0.78 |
| (7.27 ± 0.45) × 10⁷ | 81.2 | 8.97 × 107 | 23.42 |
| (3.64 ± 0.22) × 10⁷ | 129.5 | 4.56 × 107 | 25.41 |
| (1.45 ± 0.09) × 10⁷ | 315 | 1.52 × 107 | 4.87 |
| (1.09 ± 0.07) × 10⁷ | 454.8 | 1.04 × 107 | 4.18 |
| (7.27 ± 0.45) × 10⁶ | 671.2 | 7.07 × 106 | 2.74 |

Table 3 above sets out the bacterial densities as obtained by the proposed system based on the measured differential pressure across the filter and the pre-generated calibration model as compared against the agar plate count for the 24 bacterial samples that were used in this experiment.

The results for most runs agree extremely well with those from agar plate count, demonstrating that the proposed system is able to accurately predict the bacterial density in the range between 10⁶ to 10⁸ CFU/ml. The mean and median accuracies of bacterial density of the 24 runs were found to be 85.95% and 91.50%, respectively.

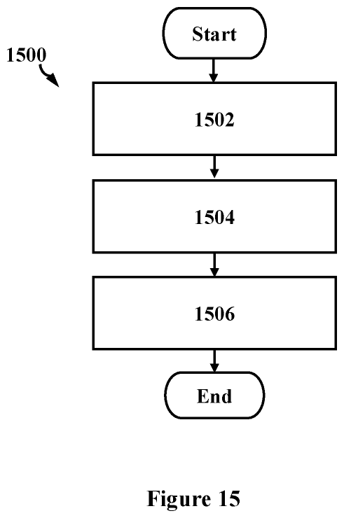

FIG. 15 illustrates process 1500 for enumerating a concentration of a microorganism in a liquid sample, whereby process 1500 may be implemented in a computing module or by modules and/or components in a system such as system 100. Process 1500 begins at step 1500 by causing a liquid sample containing an unknown concentration of a microorganism to be infused through a filtration medium for a fixed period. After the fixed period has passed, process 1500 then proceeds to cause the pressure difference across the filtration medium to be measured at step 1504. In embodiments of the disclosure, process 1500 may measure the differential pressure across the filtration medium by using a differential pressure sensor that has sensor ports that are communicatively coupled to the inlet and outlet of the filtration medium.

Once this has been done, process 1500 then proceeds to enumerate the concentration of the microorganism in the liquid sample based on the measured differential pressure across the filtration medium over a fixed period and based on the information contained in a pre-generated calibration model. This takes place at step 1506. Process 1500 then ends.

Numerous other changes, substitutions, variations, and modifications may be ascertained by the skilled in the art and it is intended that the present application encompass all such changes, substitutions, variations and modifications as falling within the scope of the appended claims.

1. A system for enumerating a concentration of a microorganism in a liquid sample, the system comprising:
a filtration medium having an inlet for receiving the liquid sample and an outlet for removing a filtered liquid sample from the filtration medium;
a differential pressure sensor having a first port connected to the inlet of the filtration medium and a second port connected to the outlet of the filtration medium, whereby the differential pressure sensor is configured to measure a pressure difference between the inlet and outlet of the filtration medium over a period;
a computing module communicatively connected to the differential pressure sensor, the computing module being configured to enumerate the concentration of the microorganism in the liquid sample based on the measured pressure difference over the period and a pre-generated calibration model.

2. The system according to claim 1, whereby the calibration model was pre-generated using a calibration module that was configured to record differential pressure measurements between the inlet and outlet of the filtration medium, record measured concentrations of the microorganism associated with the differential pressure measurements, and determine a curve fitting equation for the calibration model based on the recorded measured concentrations of the microorganism and their associated differential pressure measurements.

3. The system according to claim 1, whereby the calibration model was pre-generated using a calibration module which was configured to record measured concentrations of the microorganism, record termination time measurements associated with the measured concentrations of the microorganism, and determine a curve fitting equation for the calibration model based on the recorded measured concentrations of the microorganism and their associated recorded termination time measurements, whereby each of the termination time measurements is defined as a time required for a concentration of the microorganism to achieve a threshold value of a normalized hydraulic resistance.

4. The system according to claim 3, whereby the normalized hydraulic resistance is based on time-dependent hydraulic resistance of a measured concentration of the microorganism and on a steady-state hydraulic resistance of the filtration medium.

5. The system according to claim 3, whereby the curve fitting equation is defined by an equivalent electric circuit based numerical model that comprises a parallel circuit arrangement of a total of N number of resistors, wherein each resistor is defined as a resistance of a pore of the filtration medium.

6. The system according to claim 2, whereby when the curve fitting equation is determined, the calibration module is further configured to:
identify a blind-zone in the measurements, where the blind-zone is defined as a set of measurements whereby the recorded differential pressure measurements between the inlet and outlet of the filtration medium does not increase when the associated measured concentrations of the microorganism increases; and
removing the set of measurement associated with the blind-zone from the measurements used to determine the curve fitting equation for the calibration model.

7. The system according to claim 1, whereby the period comprises any time-period between 30 seconds and 20 minutes.

8. A computing module for enumerating a concentration of a microorganism in a liquid sample, the computing module comprising:
a processing unit; and
a non-transitory media readable by the processing unit, the media storing instructions that when executed by the processing unit, causes the processing unit to:
receive a measured pressure difference between an inlet and an outlet of a filtration medium when the liquid sample is infused through the inlet and outlet of the filtration medium over a period; and
enumerate the concentration of the microorganism in the liquid sample based on the received measured pressure difference and a pre-generated calibration model.

9. The computing module according to claim 8, wherein the non-transitory media further comprises instructions for directing the processing unit to:
receive the pre-generated calibration model, whereby the calibration model was pre-generated using a calibration module that was configured to obtain recorded differential pressure measurements between the inlet and outlet of the filtration medium, obtain recorded concentrations of the microorganism associated with the obtained recorded differential pressure measurements, and determine a curve fitting equation for the calibration model based on the obtained recorded concentrations of the microorganism and their associated recorded differential pressure measurements.

10. The computing module according to claim 8, wherein the non-transitory media further comprises instructions for directing the processing unit to:
receive the pre-generated calibration model, whereby the calibration model was pre-generated using a calibration module that was configured to obtain recorded concentrations of the microorganism, obtain recorded termination time measurements associated with the obtained recorded concentrations of the microorganism, and determine a curve fitting equation for the calibration model based on the obtained recorded concentrations of the microorganism and their associated recorded termination time measurements, whereby each of the termination time measurements is defined as a time required for a concentration of the microorganism to achieve a threshold value of a normalized hydraulic resistance.

11. The computing module according to claim 10, whereby the normalized hydraulic resistance is based on time-dependent hydraulic resistance of a measured concentration of the microorganism and on a steady-state hydraulic resistance of the filtration medium.

12. The computing module according to according to claim 10, whereby the curve fitting equation is defined by an equivalent electric circuit based numerical model that comprises a parallel circuit arrangement of a total of N number of resistors, wherein each resistor is defined as a resistance of a pore of the filtration medium.

13. The computing module according to claim 9, wherein the instructions to determine a curve fitting equation for the calibration model further comprises instructions for directing the processing unit to:
identify a blind-zone in the obtained recorded measurements, where the blind-zone is defined as a set of recorded measurements whereby the recorded differential pressure measurements between the inlet and outlet of the filtration medium does not increase when the associated recorded concentrations of the microorganism increases; and
removing the set of recorded measurement associated with the blind-zone from the recorded measurements used to determine the curve fitting equation for the calibration model.

14. A method for enumerating a concentration of a microorganism in a liquid sample, the method comprising:
infusing the liquid sample through an inlet and an outlet of a filtration medium over a period;
measuring, using a differential pressure sensor having sensor ports communicatively coupled to the inlet and outlet of the filtration medium, a pressure difference between the inlet and outlet of the filtration medium;
enumerating, using a computing module communicatively connected to the differential pressure sensor, the concentration of the microorganism in the liquid sample based on the measured pressure difference over the period and a pre-generated calibration model.

15. The method according to claim 14, whereby when the calibration model was pre-generated, the pre-generation of the calibration model comprises the steps of using a calibration module to:
record differential pressure measurements between the inlet and outlet of the filtration medium;
record measured concentrations of the microorganism associated with the differential pressure measurements; and
determine a curve fitting equation for the calibration model based on the recorded measured concentrations of the microorganism and their associated differential pressure measurements.

16. The method according to claim 14, whereby when the calibration model was pre-generated, the pre-generation of the calibration model comprising the steps of using a calibration module to:
record measured concentrations of the microorganism,
record termination time measurements associated with the measured concentrations of the microorganism, whereby each of the termination time measurements is defined as a time required for a concentration of the microorganism to achieve a threshold value of a normalized hydraulic resistance; and
determine a curve fitting equation for the calibration model based on the recorded measured concentrations of the microorganism and their associated recorded termination time measurements.

17. The method according to claim 16, whereby the normalized hydraulic resistance is based on time-dependent hydraulic resistance of a measured concentration of the microorganism and on a steady-state hydraulic resistance of the filtration medium.

18. The method according to claim 16, whereby the curve fitting equation is defined by an equivalent electric circuit based numerical model that comprises a parallel circuit arrangement of a total of N number of resistors, wherein each resistor is defined as a resistance of a pore of the filtration medium.

19. The method according to claim 15, whereby when the curve fitting equation is determined, the method further comprises the steps of using the calibration module to:
identify a blind-zone in the measurements, where the blind-zone is defined as a set of measurements whereby the recorded differential pressure measurements between the inlet and outlet of the filtration medium does not increase when the associated measured concentrations of the microorganism increases; and
remove the set of measurement associated with the blind-zone from the measurements used to determine the curve fitting equation for the calibration model.

20. The method according to claim 14, whereby the period comprises any time-period between 30 seconds and 20 minutes.
